(19) United States
(12) Patent Application Publication
(10) Pub. No.: US 2002/0073422 A1
(43) Pub. Date: Jun. 13, 2002

(54) Methods and systems for transmitting and capturing program schedules for television services

(76) Inventor: Chulhee Lee, Goyang-City (KR)

Correspondence Address: Chulhee Lee, 509-204 Dongbu-Apt, Gangsun-Maeul, Joojeob-Dong, Goyang-City, 411-744, KR

(21) Appl. No.: 09/730,548

(22) Filed: Dec. 7, 2000

(51) Int. Cl. H04N 5/445; H04N 7/173; H04N 5/44

(52) U.S. Cl. 725/40; 348/734; 725/87

(57) ABSTRACT

Methods and systems for transmitting and capturing the information of a future program whose preview is currently being broadcast and watched by a viewer. When a television station is broadcasting a preview for a future program, it transmits subsidiary or hidden information on the future program including a title, a broadcasting date, a channel number, a broadcasting time, description, and duration of the future program. Furthermore, the television station includes a special mark in the preview video signal. If a viewer is interested in the future program, the viewer can push a button in the remote control, which has the same special mark. Then the television saves the information on the future program and alerts the viewer to the program when it is about to be broadcast. If the television has an access to recording means, it may automatically record the program if the television is turned off when the program is about to be broadcast. This recording option can be selected by the viewer when the program information is saved. Since a viewer may want to change operations that are to be operated on future programs, updating means may be also provided.

### BACKGROUND OF THE INVENTION

1. Field of the Invention

This invention relates to methods and systems for transmitting and capturing a program schedule for television services, more particularly methods and systems for transmitting and capturing the information of a future program whose preview is currently being broadcast and watched by a viewer.

2. Description of the Related Art

As the number of television stations has increased, the number of programs of potential interest that are presented to a viewer has also risen significantly. In order to make it easier for viewers to select and watch programs of their interests, there have been numerous efforts. For instance, newspapers and magazines provide daily or weekly television programs and efficient methods to record future programs of interest have been proposed. Television stations are also competing for viewers' watching time since a program rating directly affects advertisement revenues for a television station. Therefore, television stations allocate a good portion of their broadcasting time for advertising their own future programs. For example, in order to draw viewers' attention, television stations frequently broadcast previews between regular programs for their future programs, such as serial television drama, sports, late night news, movies and etc. In particular, if television stations have produced special programs, they may advertise the programs days or weeks ahead of the scheduled time. Typically, when television stations broadcast such previews for future programs, they also transmit information on when and what time the programs will be broadcast. If a viewer is interested in a future program of a television station after watching a preview for the program, the viewer will try to remember the television station or the channel number. The viewer also has to remember the date and the time the future program will be broadcast. Quite often, the viewer may forget a part of the information. Sometimes, viewers completely forget about the program that they wanted to watch.

Thus, it would be desirable to provide a ready and efficient method to save information on a future program whose preview is currently being broadcast and watched by a viewer.

### SUMMARY OF THE INVENTION

In accordance with the teaching of the present invention, methods and systems to save information on a future program whose preview is being currently broadcast is provided. More particularly, when a television station is broadcasting a preview for a future program, it also transmits subsidiary or hidden information on the future program including a title, a date, a channel number, a broadcasting time, description, and duration of the program. For example, the information can be included in closed caption text. In addition, the station includes a special mark in the preview video signal. For instance, the special mark may be displayed on the upper left corner of the monitor. If a viewer is interested in the future program, the viewer can push a button in the remote control, which may have the same special mark. Then the television saves the information on the future program and reminds the viewer of the program when the viewer turns on the television on the scheduled date. If the television has an access to recording means, it may automatically record the program if the television is turned off when the program is about to be broadcast. This recording option can be selected by the viewer when the program information is saved. Since a viewer may want to change operations that are to be operated on future programs, updating means is also provided.

### BRIEF DESCRIPTION OF THE DRAWINGS

FIG. 1 is a frame of a preview that is displaying a special mark indicating that the program information of the preview is also being transmitted.

FIG. 2 illustrates a remote control that has a button of the same special mark.

FIG. 3 shows an exemplary response by the television notifying the viewer that the information of the future program is saved.

FIG. 4 shows an exemplary display of the television alerting the viewer to a chosen program when it is about to be broadcast on another channel.

FIG. 5 shows an exemplary response by the television notifying the viewer that the information of the future program is saved with the recording option on.

FIG. 6 shows an exemplary display of the television when the viewer requests the list of the future programs that the viewer indicated to watch.

FIG. 7 shows an exemplary display of the television when the viewer selects a different program in order to change operation option.

FIG. 8 shows an exemplary display of the television when the viewer activates a recording option on the selected program.

FIG. 9 shows an exemplary display of the television when the viewer requests detailed information on the selected program.

FIG. 10 shows other possible examples of the special mark indicating that the program information of a preview is also being broadcast.

FIG. 11 illustrates how information on a future program can be encoded in closed caption text.

FIG. 12 shows how information on a future program can be encoded in closed caption text using a character sequence.

FIG. 13 shows how text, which is displayed at the bottom of the television monitor, can be used to inform a viewer about a future program while a different program is currently being broadcast.

FIG. 14 shows how text, which is displayed at the bottom of the television monitor, can be used to inform a viewer about future program schedule while a different program is currently being broadcast.

FIG. 15 shows an exemplary display of the television when the viewer indicates interest in the future programs that were being advertised using text which is displayed at the bottom of the television monitor.

FIG. 16 shows an exemplary display of the television when the viewer selects one of the future programs that were being advertised using text which is displayed at the bottom of the television monitor.

FIG. 17 illustrates how information on a plurality of future programs can be encoded in closed caption text.

FIG. 18 shows an exemplary display of the television when the television station broadcasts its program schedule in the following hours.

### DESCRIPTION OF THE ILLUSTRATED EMBODIMENTS

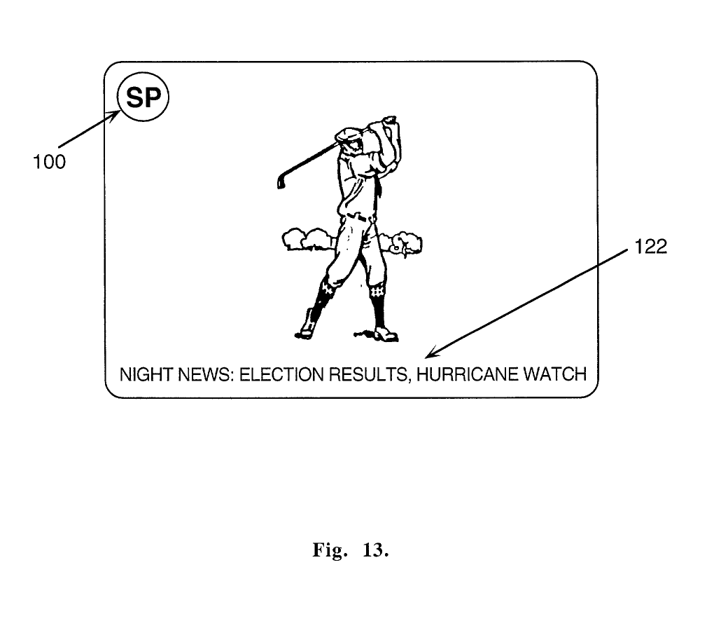

In order to draw viewers' attention, television stations frequently broadcast previews for their future programs between regular programs. Sometimes, a television station transmits information on its future programs while a regular program is being broadcast. For instance, the station transmits information on the night news that will be broadcast later using text which is displayed at the bottom of the monitor as shown in FIG. 13. Typically, television stations use this kind of advertisement for their future programs that will be broadcast later on the same day. On the other hand, they may use previews between regular programs in order to advertise their future programs that will be broadcast in the future. However, a television station may use previews between regular programs to advertise a future program if it is a major program or can be better advertised with a preview, even though it is going to be broadcast later on the same day. In either case, it would be desirable to provide ready means to save information on a future program whose preview is currently being broadcast so that the viewer will be reminded of the program when it is about to be broadcast.

Embodiment 1

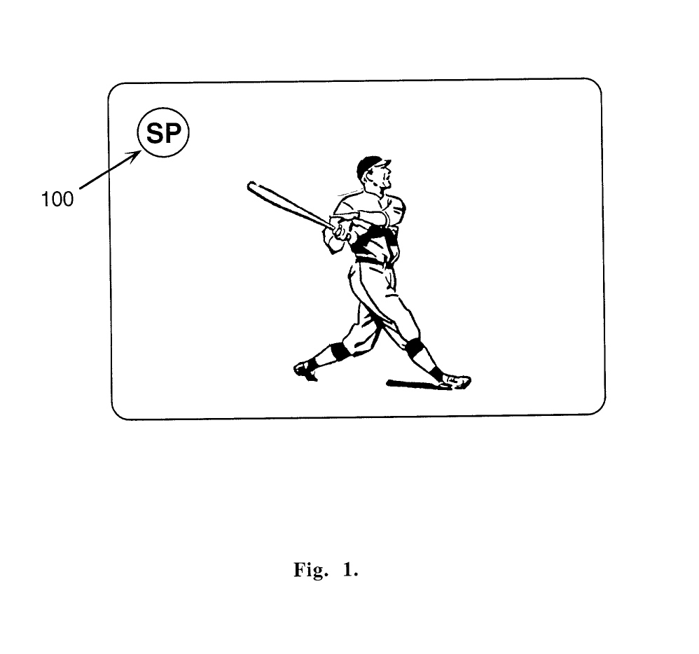

FIG. 1 shows a frame of a preview that is displaying a special mark 100 indicating that program information of the preview is also being broadcast. The program information includes a local time of the television station, a title, a broadcasting date, a broadcasting time, a channel number, description and duration of the program. The information needs to be transmitted invincibly and may be transmitted in closed caption text. The information may be also received from vertical blanking intervals or a digital channel.

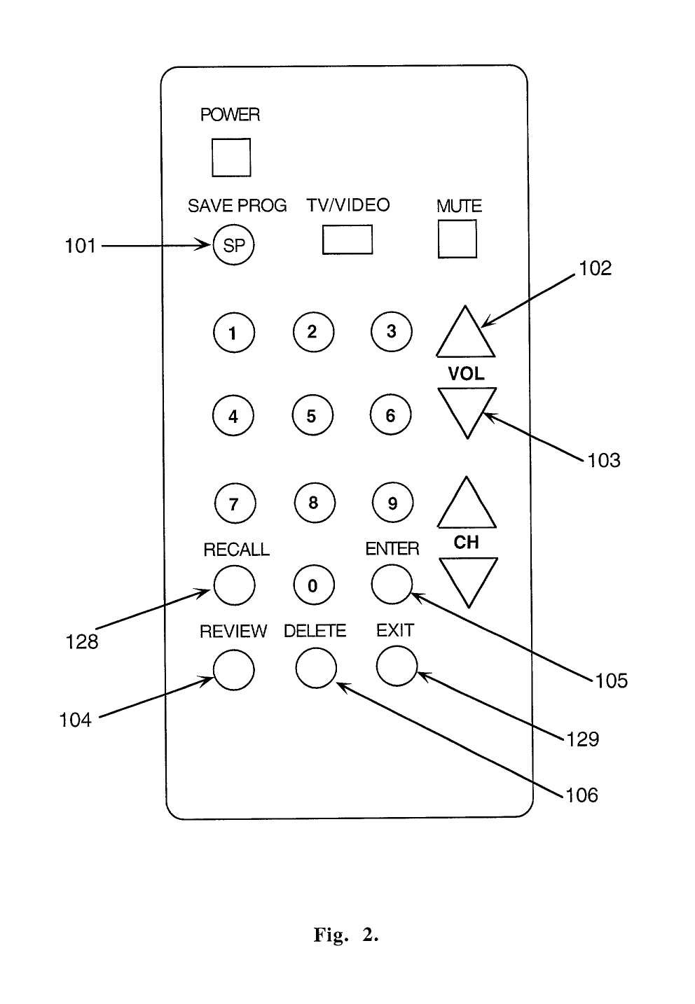

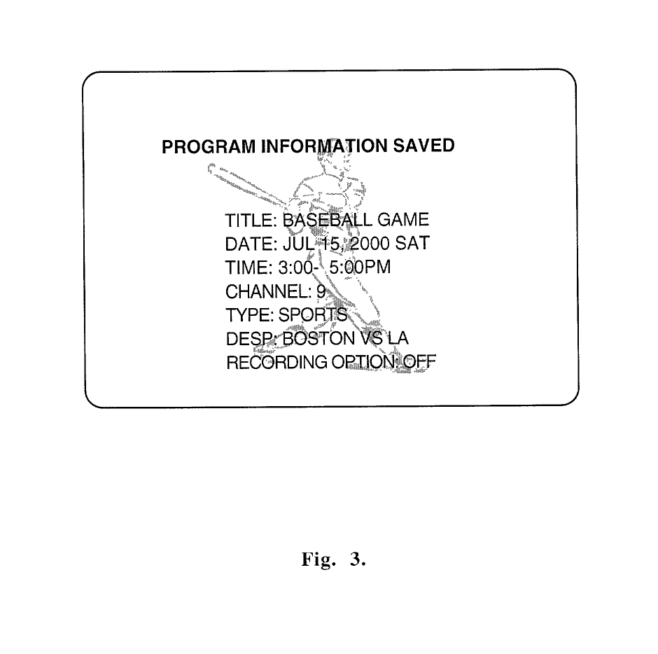

If a viewer is interested in the future program whose preview is currently being broadcast, the viewer can push the SP (Save Program information) button 101 on the remote control that may have the same special mark, as shown in FIG. 2. Then, the television saves the information of the future program including a title, a broadcasting date, a broadcasting time, a channel number, description, and duration of the program. After the program information is saved, the television may display a response notifying that the program information is saved, as illustrated in FIG. 3. If a television station broadcasts a preview for a daily or weekly program, the television station may include such information in the program description. For example, the television station may include a word, ‘daily’ or ‘weekly’, in the program description. If the viewer wants to watch the program every time it is broadcast, the viewer can select a periodic watching option, which may be selected by pressing a button when the television displays a response of FIG. 3. For instance, the viewer may select the periodic watching option by pressing the RECALL 128 button when the television displays a response of FIG. 3. If the periodic watching option is selected, the television will alert the viewer to the program every time it is broadcast. Sometimes, the television station may change its broadcasting schedule. When the television station is going to change a broadcasting time for a program, it may transmit a new broadcasting time for the program invincibly while the program is being broadcast. For example, the new broadcasting time can transmitted in closed caption text. The new broadcasting time may be coded in a special format so that the television can determine whether closed caption text is intended for caption text or a new broadcasting time. If the television detects a new broadcasting time for a program for which the periodic watching option is selected, it may update the new broadcasting time accordingly.

If the television has an access to recording means, it may also record the preview in order to provide more information and convenience when the viewer wants to review chosen programs that the viewer indicated to watch. In other words, when viewers review chosen programs, they can replay the previews and decide whether they are still interested in the programs. In this case, the television needs to record previews constantly. Thus, video needs to be recorded in digital format. In this case, the recording means comprises video and audio codec (coder/decoder), control units and storage such as a hard drive or RAM (random access memory). The function of the codec is to encode and decode a signal.

A possible problem is that the time kept by the television may be different from the time kept by the broadcasting station. This problem may occur since the broadcasting station and the television maintain separate clocks. And the time among clocks of different television stations may not be identical. Furthermore, the viewer and the television station can be located in different time zones. If this is the case, the time difference can be several hours. If the time difference is relatively small (e.g., a few seconds), it would not be a problem. However, if the difference is large enough, it may cause a problem when the television needs to alert the viewer to a chosen program when it is about to be broadcast. In order to address this problem, the broadcasting station may include its local time in the information on the future program. Then the television checks whether the time difference is reasonably small. If the difference is large, the television needs take it into account to determine the time the future program will be broadcast. Another possible solution to address this time difference problem would be to transmit the time interval between the present time and the future time when the program is to be broadcast. For example, the television station may transmit information in such a way that the program, whose preview is currently being broadcast, will be broadcast after 20 hours and 26 minutes. Then, the television can compute the broadcasting time in its local time and save it.

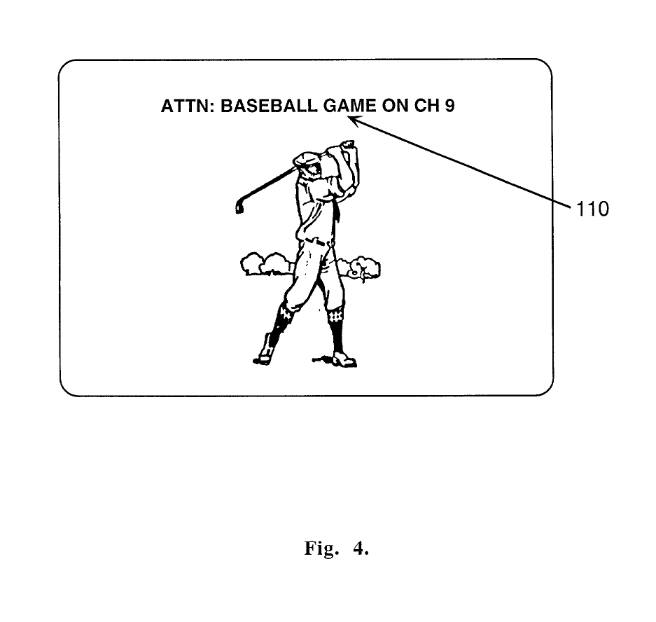

When one of the programs that the viewer indicated to watch is about to be broadcast, the television needs to alert the viewer to the program. This can be done by displaying a special message 110 on television as illustrated in FIG. 4. In addition, it may provide an audio tone over the speaker system. If the television is not turned on, it may turn on itself and alert viewers by providing an audio signal. The television may turn off itself again if there is no pushing activity of the remote control for a certain duration of time since no such activity indicates that the viewer may not be at home.

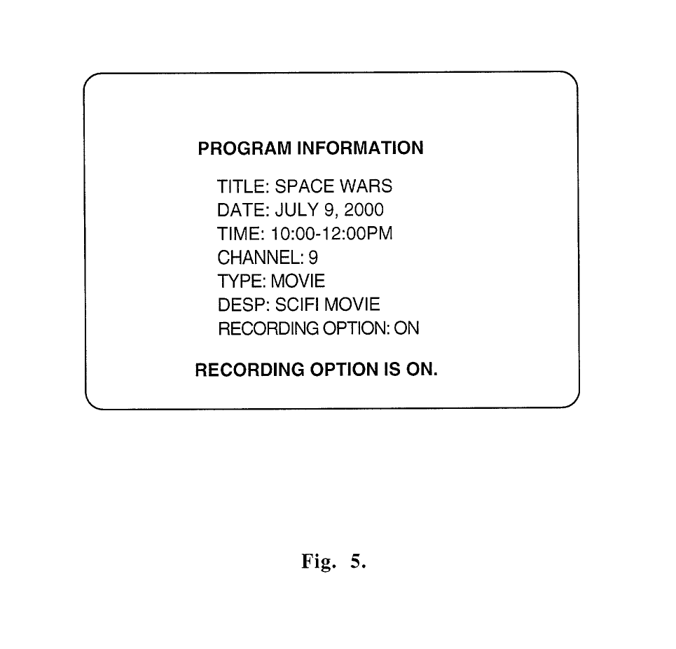

If the television has an access to recording means, it may automatically record the program if the television is turned off when the program is about to be broadcast. This recording option can be selected by the viewer when the program information is saved. In other words, if the viewer wants to record the program in case that he is not able to watch it, the viewer can direct the television to record the program. For instance, it can be done by pushing the SP button 101 one more time. Then the television may acknowledge that the recording option is selected as shown in FIG. 5. The recording means may comprise control units and video cassette recorder. One may record the program in digital format. In this case, the recording means may comprise video and audio codec, control units and storage such as a hard drive.

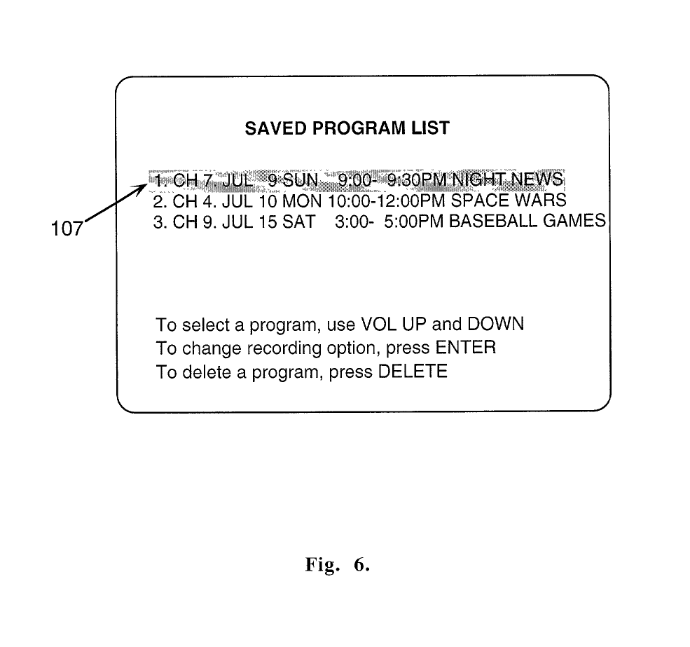

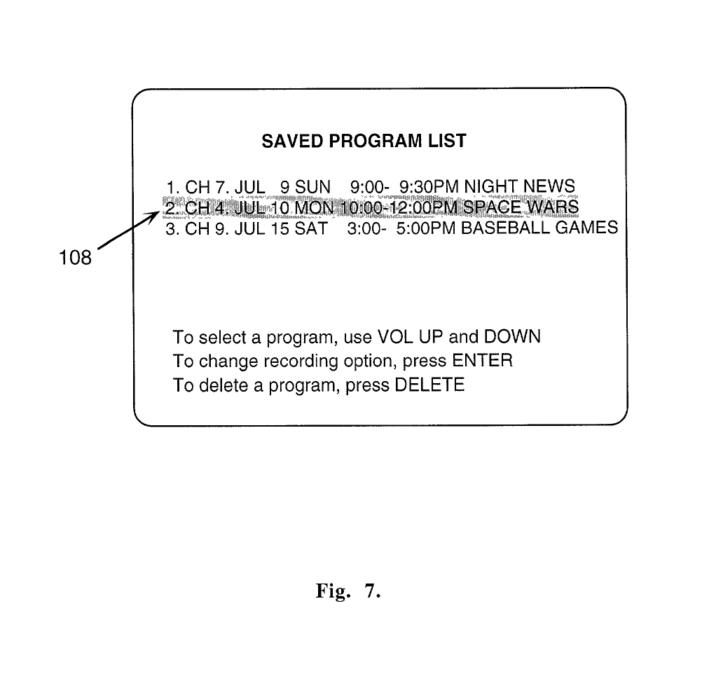

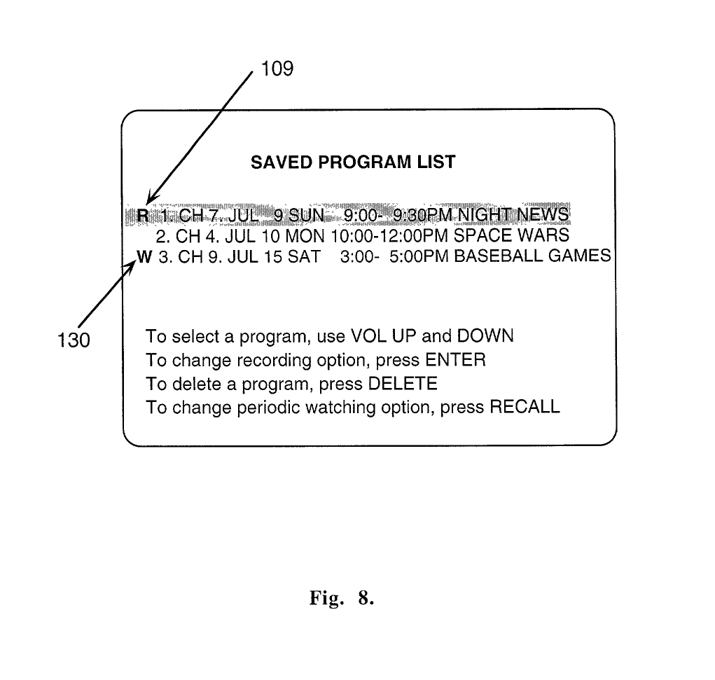

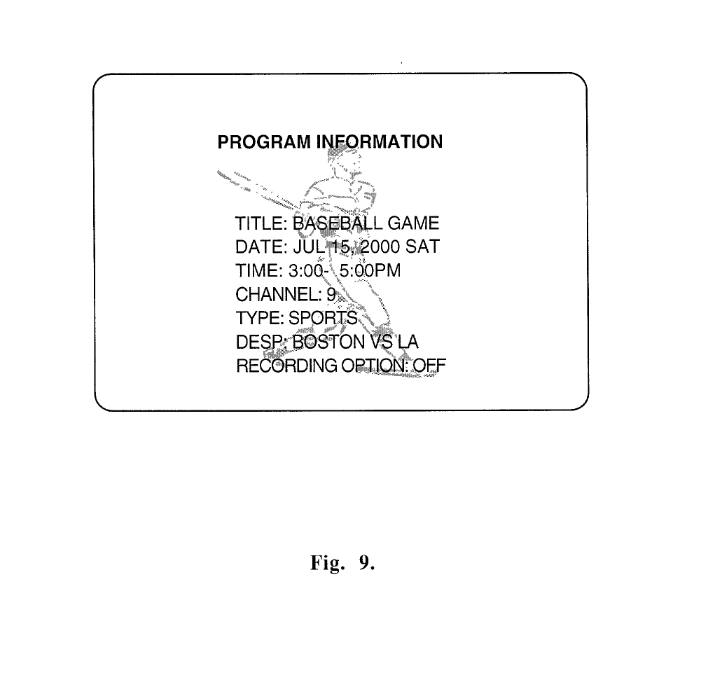

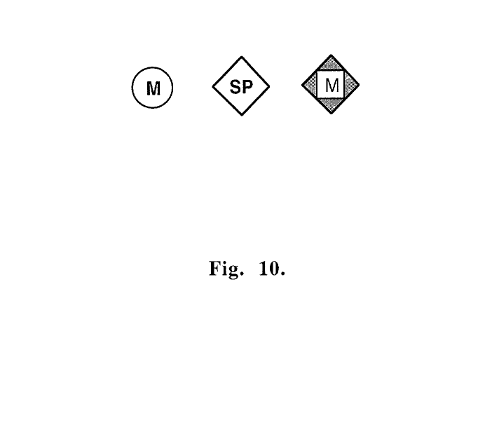

If the viewer wants to review a list of chosen programs, the viewer may push the REVIEW 104 button and the television will respond by displaying the list of chosen programs as illustrated in FIG. 6. After reviewing the list, the viewer may want to delete some of the programs. In order to delete a program, the viewer first needs to select a program 107 which will be highlighted as shown in FIG. 6. As illustrated in FIG. 7, the viewer may selected a different program 108 by pushing the volume UP 102 and DOWN 103 buttons of the remote control of FIG. 2. Once a program is selected, the viewer can delete the selected program, which is highlighted, by pushing the DELETE 106 button. If the viewer wants to change the recording option, he may push the ENTER 105 button, which toggles the recording option. For instance, in FIG. 8, the character “R” 109 indicates that the recording option is selected and the television will record the program if it is turned off when the program is about to be broadcast. The character “W” 130 in FIG. 8 indicates that the program is a weekly program and the periodic watching option was selected. The periodic watching option can be toggled using the RECALL 128 button. If the viewer wants detailed information of the selected program, the viewer may push the REVIEW 104 button again and the television displays the detailed information on the selected program as shown in FIG. 9. FIG. 10 shows other possible special marks, which can be used to indicate that the program information of a preview is also being transmitted. The special mark can be made blinking to draw attention of viewers and may have some bright colors.

The information on future programs needs to be transmitted invincibly. For instance, the information can be included in closed caption text. The information can be also received from vertical blanking intervals or a digital channel. If the information is transmitted in closed caption text, there should be a kind of protocol so that the television can determine whether closed caption text is intended for caption text or program information. A possible solution is that the program information can be arranged in a special format when closed caption text is used to transmit program information.

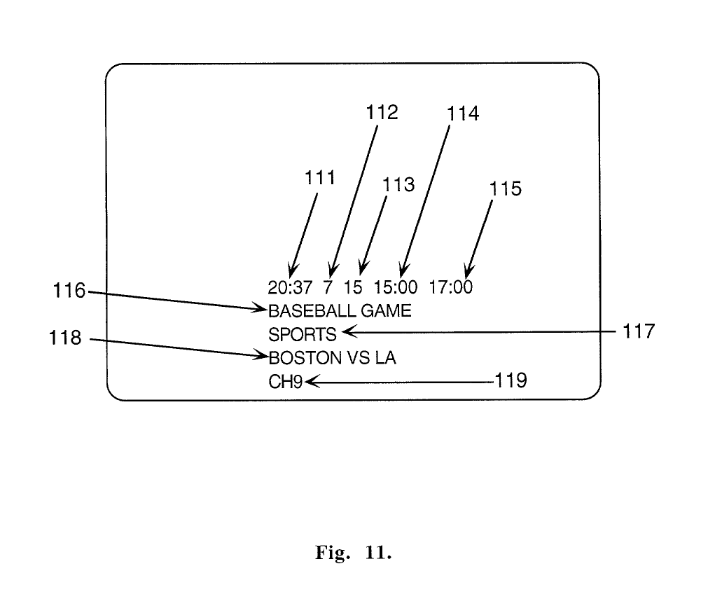

FIG. 11 shows a possible example of such a format. The first term in the first line, “20:37” 111, is the local time of the television station. It is noted that the hour and the minute are separated by a colon. The following numbers, “7” 112 and “15” 113, indicate that the program will be broadcast on July 15. By assuming that the broadcasting date will be within one year, the information on the year may be omitted without causing any ambiguity. The following term, “15:00” 114, is the starting time and “17:00” 115, the ending time in the local time of the television station. Instead of using the start and end times, the duration of the program may be used. The text in the second line 116 is the title of the program and the text in the third line 117 is the type of the program. The text in the fourth line 118 is an additional description of the program. The term in the fifth line, “CH9” 119, is the channel number. The channel number may be omitted since the program will be broadcast on the same channel as the preview is broadcast in most cases. Instead, the station name can be transmitted. Since ordinary caption text rarely has the form of FIG. 11, the television can interpret the closed caption text in the format of FIG. 11 as program information for a future program and determine not to display the text even when the closed caption display option is selected. In this way, the television can also determine whether the current video is a preview or not. Furthermore, in order to reduce the amount of information to be transmitted, the program information may be compressed using some compression algorithms or can be encoded in a more efficient way. In addition, some of the information, which is not essential, may be omitted in order to reduce the text size. For instance, only the essential information, which includes the local time of the television station, the start and end times, and the broadcasting date of the future program, may be compressed and transmitted. After compression, the information would be represented by a sequence of characters which does not make any sense grammatically. Therefore, if the closed caption text is such a sequence of characters, the television may determine that it is program information and decompress the sequence of characters. Sometimes, the closed caption text may be damaged and some of the program information may be lost. Thus, it may be desirable to compress the essential information using compression algorithms that are robust to errors.

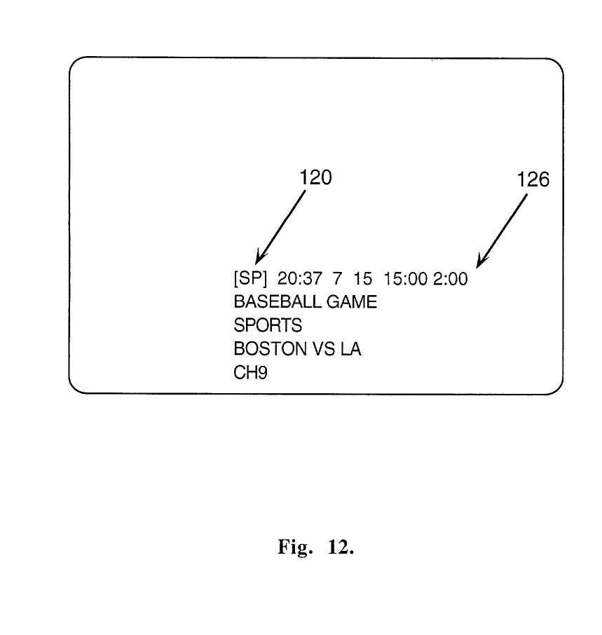

Another possible solution to determine whether closed caption text is intended for caption text or program information is to use a sequence of characters that would rarely appear in ordinary caption text. For instance, in FIG. 12, a character sequence, “[SP]” 120, is used to indicate that the following text is the program information. In FIG. 12, the duration of the program 126 is used instead of using the start and end times. Once the closed caption text is determined to be the program information, the television may choose not to display it. In order to reduce the text size, some of the information, which is not essential, may be omitted and the remaining information may be compressed using some compression algorithms as previously.

Embodiment 2

Sometimes, a television station transmits information on the future programs while a regular program is being broadcast. For instance, in FIG. 13, the station transmits information on a night news program, which will be broadcast later, using the text 122 that is displayed at the bottom of the monitor. Typically, television stations use this kind of advertisement for their future programs that will be broadcast later on the same day. The teaching of the present invention can be also used in this case. In other words, the video signal includes the same special mark 100 that is displayed on the television monitor, informing viewers that information on the program, whose information is being displayed as text at the bottom of the monitor, is available and can be saved using the SP button 101 that has the same special mark.

Embodiment 3

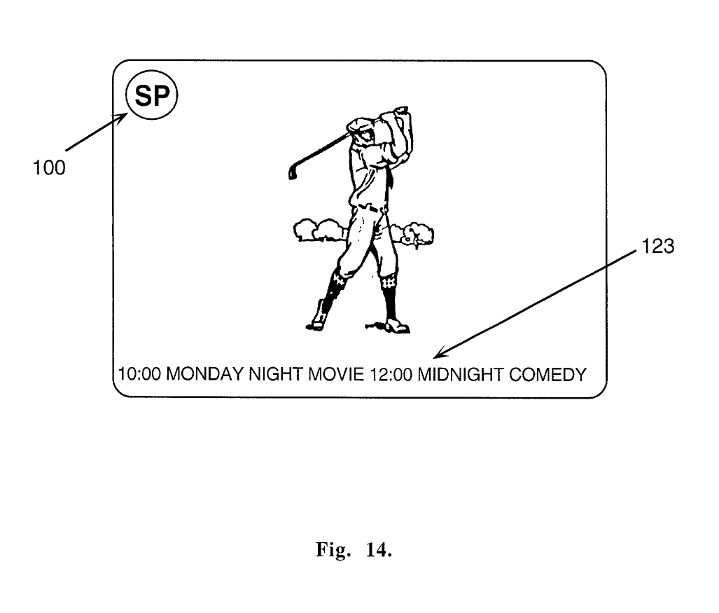

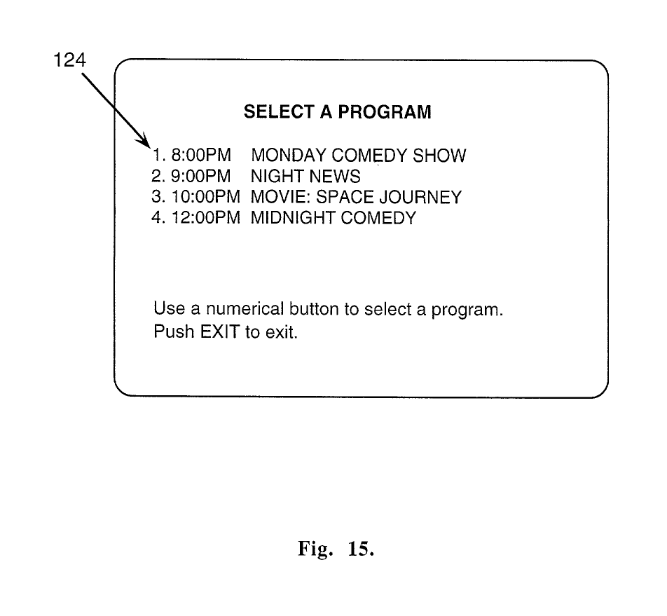

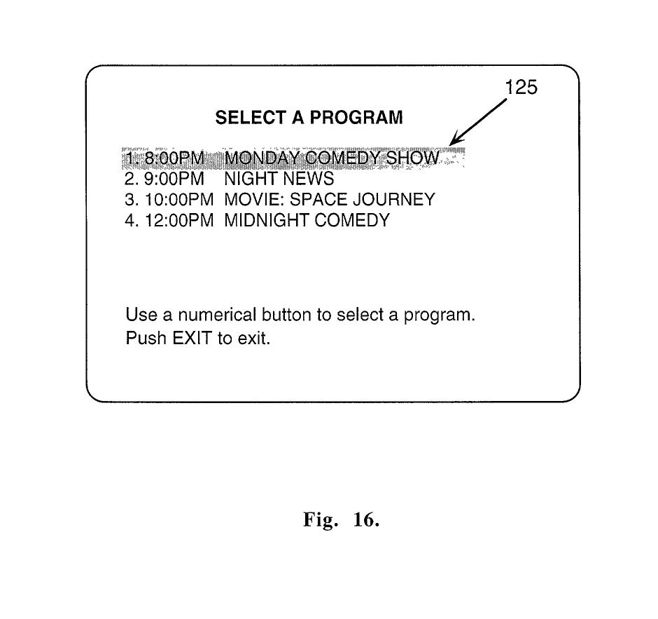

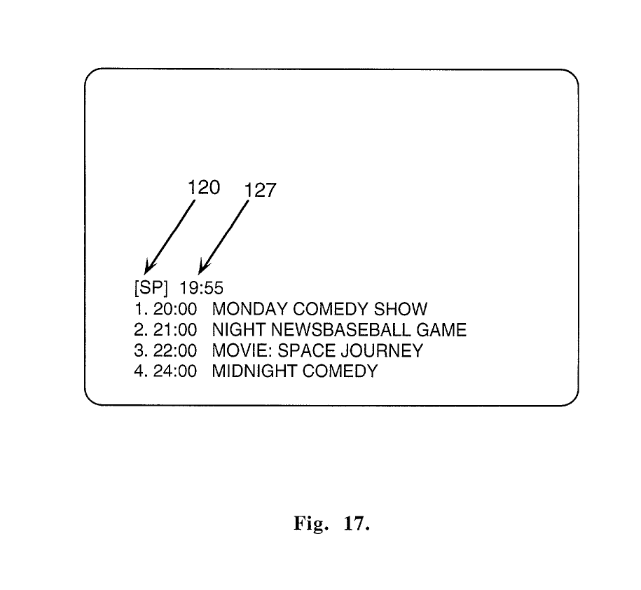

In other cases, a television station may advertise a plurality of future programs that will be broadcast on the same day using the text 123 which is displayed at the bottom of the monitor as shown in FIG. 14. Usually, television stations use this kind of advertisement at the end of a regular program. Since the television station advertise several programs at the same time in this case, the response of the television should be different when the viewer presses the SP button 101. If the viewer presses the SP button 101, the television activates a selection mode and displays the list of the programs that were advertised. And the viewer can choose the programs that he is interested in watching. For instance, in FIG. 15, the television displays a plurality of programs that were advertised. If the viewer wants to watch the first program, the viewer may select the program by pushing a numerical button on the remote control, which corresponds to the index number 124. If the viewer selects a program, the selected program 125 can be made highlighted as shown in FIG. 16. When the viewer finishes selecting programs, the viewer may exit the selection mode by pushing the EXIT 127 button. FIG. 17 illustrates how information on multiple future programs can be encoded in closed caption text. First, a character sequence, “[SP]” 120, is used to indicate that the following text is the program information. The second term in the first line, “19.55” 111, is the local time of the television station. And the following text is the program information for the future programs. Since the format of FIG. 16 is different from that of FIG. 12, the television can easily determine whether the program information is for a program or for a plurality of future programs. In order to reduce the amount of information to be transmitted, the text program information may be compressed using some compression algorithms or can be encoded in a more efficient way. Furthermore, some of the information may be omitted in order to reduce the text size.

Embodiment 4

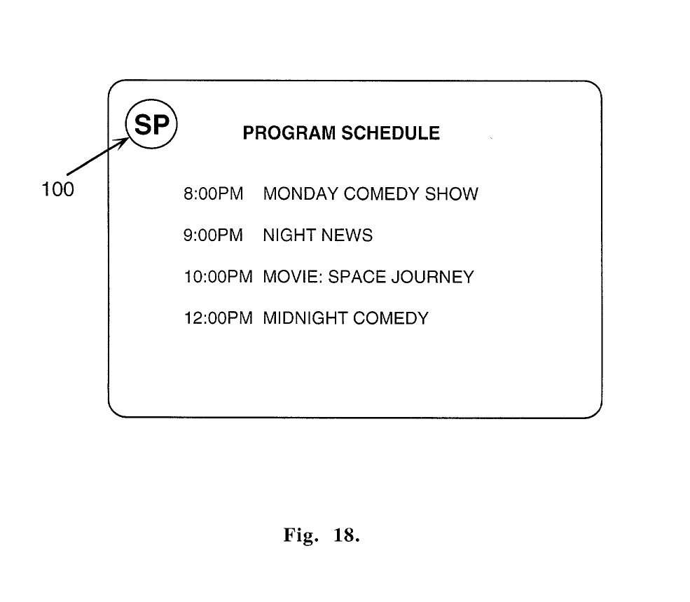

Sometimes, a television station advertises its future programs by displaying a program schedule in the following hours as illustrated in FIG. 18. The teaching of the present invention can be also used in this case. In other words, the video signal includes the same special mark 100 that is displayed on the television monitor, informing viewers that information on the programs is being transmitted and can be saved using the SP button 101 that has the same special mark. If a viewer pushes the SP button 101, the response of the television can be the same as that of EMBODIMENT 3.

What is claimed is:

1. A method for transmitting and capturing information of a future program whose preview is currently being broadcast between regular programs comprising:
a television;
a remote control;
a preview for a future program;
program information for said future program;
sending means that transmits said program information, comprising closed caption text;
indicating means for indicating that said program information is being transmitted, comprising a special mark displayed on said television;
saving means for directing said television to save said program information in case that a viewer chooses to watch, comprising a saving button on said remote control;
reviewing means that displays a list of chosen programs, comprising a reviewing button on said remote control;
alerting means that alerts viewers to a chosen program when it is about to be broadcast; and
updating means that changes operations that is to be operated on said chosen programs.

2. The method in accordance with claim 1 wherein said program information comprises a local time of a television station that is broadcasting said preview, a title of said future program, a broadcasting date of said future program, a broadcasting time of said future program, a channel number of said future program, description of said future program, and duration of said future program.

3. The method in accordance with claim 1 wherein said alerting means comprises audio signal which alerts viewers aurally, video signal which alerts viewers visually, automatic turn-on means which turns on said television automatically when it is turned off, and automatic turn-off means which turns off said television in case that there is no pushing activity of said remote control for a certain duration of time after said television is automatically turned on.

4. The method in accordance with claim 1 wherein said updating means comprises selecting means which selects a program from said chosen programs comprising volume up and down buttons on said remote control, periodic watching toggling means which toggles a periodic watching option for a program of said chosen programs comprising a recalling button on said remote control, and deleting means which delete a program from said chosen programs comprising a delete button on said remote control.

5. A method for transmitting and capturing information of a future program whose preview is currently being broadcast between regular programs comprising:
a television;
a remote control;
a preview for a future program;
program information for said future program;
sending means that transmits said program information, comprising closed caption text;
indicating means for indicating that said program information is being transmitted, comprising a special mark displayed on said television;
saving means for directing said television to save said program information in case that a viewer chooses to watch, comprising a saving button on said remote control;
reviewing means that displays a list of chosen programs, comprising a reviewing button on said remote control;
alerting means that alerts viewers to a chosen program when it is about to be broadcast;
updating means that changes operations that is to be operated on said chosen programs; and
recording means.

6. The method in accordance with claim 5 wherein said program information comprises a local time of a television station that is broadcasting said preview, a title of said future program, a broadcasting date of said future program, a broadcasting time of said future program, a channel number of said future program, description of said future program, and duration of said future program.

7. The method in accordance with claim 5 wherein said alerting means comprises audio signal which alerts viewers aurally, video signal which alerts viewers visually, automatic turn-on means which turns on said television automatically when it is turned off, and automatic turn-off means which turns off said television in case that there is no pushing activity of said remote control for a certain duration of time after said television is automatically turned on.

8. The method in accordance with claim 5 wherein said updating means comprises selecting means which selects a program from said chosen programs comprising volume up and down buttons on said remote control, deleting means which delete a program from said chosen programs comprising a deleting button on said remote control, periodic watching toggling means which toggles a periodic watching option for a program of said chosen programs comprising a recalling button on said remote control, and recording toggling means which toggles a recording option for a program of said chosen programs comprising an entering button on said remote control.

9. The method in accordance with claim 5 wherein said recording means comprises video and audio codec, control units and a hard drive.

10. A method for transmitting and capturing information of a future program which is currently being advertised while another program is being broadcast comprising:
a television;
a remote control;
textual advertisement for a future program, which is currently being displayed on said television while another program is being broadcast;
program information for said future program;
sending means that transmits said program information, comprising closed caption text; indicating means for indicating that said program information is being transmitted,
comprising a special mark displayed on said television; saving means for directing said television to save said program information in case that a viewer chooses to watch, comprising a saving button on said remote control;
reviewing means that displays a list of chosen programs, comprising a reviewing button on said remote control;
alerting means that alerts viewers to a chosen program when it is about to be broadcast; and
updating means that changes operations that is to be operated on said chosen programs.

11. The method in accordance with claim 10 wherein said textual advertisement comprises a title of said future program, a broadcasting time of said future program, and a brief description of said future program.

12. The method in accordance with claim 10 wherein said program information comprises a local time of a television station that is broadcasting said textual advertisement, a title of said future program, a broadcasting date of said future program, a broadcasting time of said future program, a channel number of said future program, description of said future program, and duration of said future program.

13. The method in accordance with claim 10 wherein said alerting means comprises audio signal which alerts viewers aurally, video signal which alerts viewers visually, automatic turn-on means which turns on said television automatically when it is turned off, and automatic turn-off means which turns off said television in case that there is no pushing activity of said remote control for a certain duration of time after said television is automatically turned on.

14. The method in accordance with claim 10 wherein said updating means comprises selecting means which selects a program from said chosen programs comprising volume up and down buttons on said remote control, periodic watching toggling means which toggles a periodic watching option for a program of said chosen programs comprising a recalling button on said remote control, and deleting means which delete a program from said chosen programs comprising a delete button on said remote control.

15. A method for transmitting and capturing information of a plurality of future programs which are currently being advertised while another program is being broadcast comprising:
a television;
a remote control;
textual advertisement for a plurality of future programs, which is currently being displayed on said television while another program is being broadcast;
program information for said future programs;
sending means that transmits said program information, comprising closed caption text;
indicating means for indicating that said program information is being transmitted, comprising a special mark displayed on said television;
saving means for directing said television to save said program information of some of said future programs that a viewer chooses to watch;
reviewing means that displays a list of chosen programs, comprising a reviewing button on said remote control;
alerting means that alerts viewers to a chosen program when it is about to be broadcast;
updating means that changes operations that is to be operated on said chosen programs; and
recording means.

16. The method in accordance with claim 15 wherein said textual advertisement comprises titles of said future programs and broadcasting times of said future programs.

17. The method in accordance with claim 15 wherein said program information comprises a local time of a television station that is broadcasting said textual advertisement, titles of said future programs, broadcasting dates of said future programs, broadcasting times of said future programs, channel numbers of said future programs, description of said future programs, and duration of said future programs.

18. The method in accordance with claim 15 wherein said saving means comprises a saving button on said remote control which activates selection mode, numerical buttons to select a program from said future programs when said selection mode is activated, and an exit button to exit said selection mode.

19. The method in accordance with claim 15 wherein said alerting means comprises audio signal which alerts viewers aurally, video signal which alerts viewers visually, automatic turn-on means which turns on said television automatically when it is turned off, and automatic turn-off means which turns off said television in case that there is no pushing activity of said remote control for a certain duration of time after said television is automatically turned on.

20. The method in accordance with claim 15 wherein said updating means comprises selecting means which selects a program from said chosen programs comprising volume up and down buttons on said remote control, deleting means which delete a program from said chosen programs comprising a deleting button on said remote control, periodic watching toggling means which toggles a periodic watching option for a program of said chosen programs comprising a recalling button on said remote control, and recording toggling means which toggles a recording option for a program of said chosen programs comprising an entering button on said remote control.

21. The method in accordance with claim 15 wherein said recording means comprises video and audio codec, control units and a hard drive.

22. A method for transmitting and capturing information of a plurality of future programs which are currently being advertised comprising:
a television;
a remote control;
textual advertisement for a plurality of future programs, which is currently being broadcast on said television;
program information for said future programs;
sending means that transmits said program information, comprising closed caption text;
indicating means for indicating that said program information is being transmitted,
comprising a special mark displayed on said television;
saving means for directing said television to save said program information of some of said future programs that a viewer chooses to watch;
reviewing means that displays a list of chosen programs, comprising a reviewing button on said remote control;
alerting means that alerts viewers to a chosen program when it is about to be broadcast;
updating means that changes operations that is to be operated on said chosen programs; and
recording means.

23. The method in accordance with claim 22 wherein said textual advertisement comprises titles of said future programs and broadcasting times of said future programs.

24. The method in accordance with claim 22 wherein said program information comprises a local time of a television station that is broadcasting said textual advertisement, titles of said future programs, broadcasting dates of said future programs, broadcasting times of said future programs, channel numbers of said future programs, description of said future programs, and duration of said future programs.

25. The method in accordance with claim 22 wherein said saving means comprises a saving button on said remote control which activates selection mode, numerical buttons to select a program from said future programs when said selection mode is activated, and an exit button to exit said selection mode.

26. The method in accordance with claim 22 wherein said alerting means comprises audio signal which alerts viewers aurally, video signal which alerts viewers visually, automatic turn-on means which turns on said television automatically when it is turned off, and automatic turn-off means which turns off said television in case that there is no pushing activity of said remote control for a certain duration of time after said television is automatically turned on.

27. The method in accordance with claim 22 wherein said updating means comprises selecting means which selects a program from said chosen programs comprising volume up and down buttons on said remote control, deleting means which delete a program from said chosen programs comprising a deleting button on said remote control, periodic watching toggling means which toggles a periodic watching option for a program of said chosen programs comprising a recalling button on said remote control, and recording toggling means which toggles a recording option for a program of said chosen programs comprising an entering button on said remote control.

28. The method in accordance with claim 22 wherein said recording means comprises video and audio codec, control units and a hard drive.
